(19) United States
(12) Patent Application Publication
(10) Pub. No.: US 2013/0095462 A1
(43) Pub. Date: Apr. 18, 2013

(54) UNIVERSAL TEST AND QUESTIONNAIRE SYSTEMS

(71) Applicant: Tobias Ternström, Kirkland, WA (US)

(72) Inventor: Tobias Ternström, Kirkland, WA (US)

(21) Appl. No.: 13/272,002

(22) Filed: Oct. 12, 2011

(51) Int. Cl. G09B 7/00

(52) U.S. Cl. 434/322

(57) ABSTRACT

Examples of systems and methods for creating, managing, and administering test, questionnaires, or both, are described. Described systems and methods may also provide for reporting and profile analysis. Language support may be provided such that tests or questionnaires may be administered in different languages, and reports may be generated in a same or different language as the language used to administer the test or questionnaires.

### TECHNICAL FIELD

Embodiments of the invention relate generally to universal test systems including computer systems for providing tests or questionnaires and computer systems for generating and disseminating reports regarding test or questionnaire results.

### BACKGROUND

Tests or questionnaires are used by a variety of enterprises to assess individuals or groups. Examples of testing that may be desirable for enterprises include personality testing, aptitude testing, customer satisfaction testing, and the like.

Enterprises may utilize the results of testing to perform a variety of functions, including hiring, managing, or targeting product offerings.

### BRIEF DESCRIPTION OF THE DRAWINGS

FIG. 1 is a schematic illustration of a computing system arranged in accordance with an embodiment of the present invention.

FIG. 2 is a schematic illustration of a user interface for providing information to a computing system for use in generating a test, questionnaire, or both.

FIG. 3 is a schematic illustration of a user interface for adding questions to a test or questionnaire in accordance with an embodiment of the present invention.

FIG. 4 is a flowchart of a method of generating and providing a text or questionnaire in accordance with embodiments of the present invention.

FIG. 5 is a schematic illustration of a report displayed in accordance with an embodiment of the present invention.

FIG. 6 is a flowchart illustrating a method of providing reports in accordance with an embodiment of the present invention.

FIG. 7 is a flowchart illustrating a method for providing profile analysis according to an embodiment of the present invention.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known computer system components, peripherals, circuits, control signals, and software operations have not been shown in detail in order to avoid unnecessarily obscuring the described embodiments of the invention.

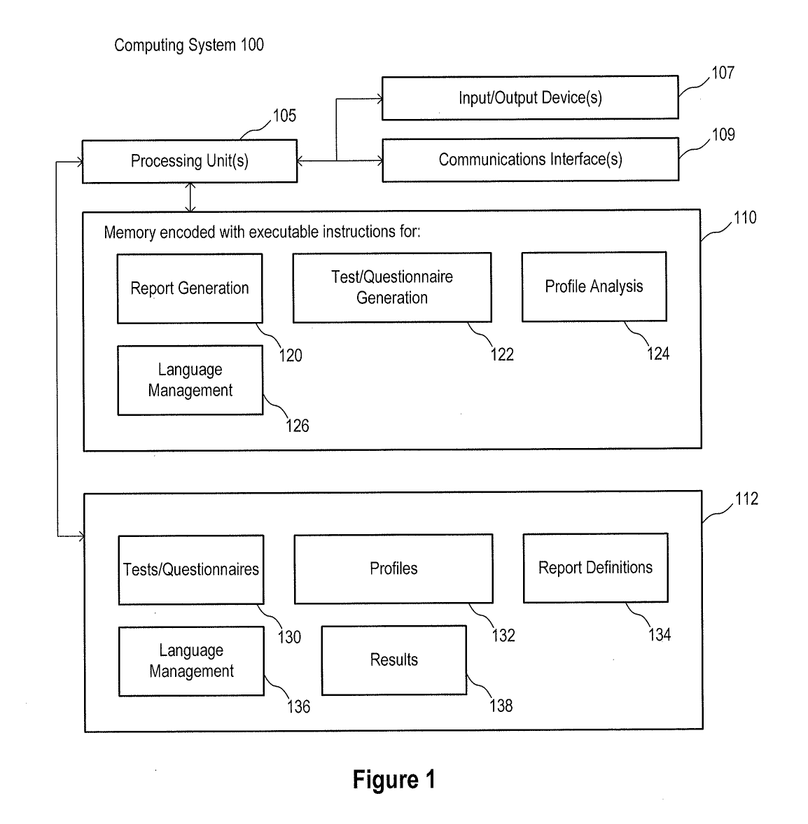

FIG. 1 is a schematic illustration of a computing system arranged in accordance with an embodiment of the present invention. Computing system 100 may generally include one or more processing unit(s) 105, input/output device(s) 107, communications interface(s) 109, memory encoded with executable instructions 110, and other electronic storage 112.

Any type and number of processors, including a single processor, may be used to implement the processing unit(s) 105. The input/output device(s) 107 may include, but are not limited to, a mouse, keyboard, display, or touch screen. The communications interface(s) 109 may include, but are not limited to, a network interface, including a wireless interface. Any type or number of memory devices may be used to implement the memory 110 encoded with executable instructions including, but not limited to volatile or non-volatile memory, RAM, ROM, or flash memory, CD, DVD, hard drives, or USB drives. Similarly, any type or number of memory devices may be used to implement the other storage 112, including, but not limited to volatile or non-volatile memory, RAM, ROM, or flash memory, CD, DVD, hard drives, USB drives, and the other storage 112 may be in communication with the processing unit(s) 105 over an internal bus or other connection, or may be in communication with the processing unit(s) over a network connection—either a wide or local area network. In some embodiments, one storage device may implement both the memory 110 and other storage 112, or portions thereof. It is to be understood that the arrangement of computing components is quite flexible, and any type, number, or arrangement or processing unit(s) and memory may be used in cooperation as described further below to implement the described features.

During operation of the system, the executable instructions encoded on the memory 110 may operate in cooperation with the processing unit(s) 105 to perform certain functionality. The executable instructions may include instructions for report generation 120, test or questionnaire generation 122, profile analysis 124, language management 126, or combinations thereof. During operation of the system, the executable instructions encoded on the memory 110 in cooperation with the processing unit(s) 105, may make use of data stored in the other storage 112, or may store data in the other storage 112. Data that may be included in the other storage 112 may include, but is not limited to, tests or questionnaires 130, profiles 132, report definitions 134, reports 136, results 138, or combinations thereof.

The computing system 100 may be in communication and operate in cooperation with additional computing systems (not shown in FIG. 1). Client computing systems may be used to display tests or questionnaires in a manner specified by the computing system 100. Client computing systems may obtain responses to the tests or questionnaires, and communicate results back to the computing system 100. In other examples, input/output devices 107 of the computing system 100 itself may be used to display test or questionnaires and receive results.

Embodiments of systems and methods for generating tests or questionnaires will now be described. Questionnaire is used herein to refer to a series of questions or other prompts that may be posed to a user, but are not designed to receive scores associated with the answers. Test is used herein to refer to a series of questions or other prompts that may be posed to a user and designed to be scored in accordance with a scoring criteria. Examples of systems according to the present invention, such as the computing system 100 of FIG. 1, may allow users to generate custom tests, questionnaires, or both, in a flexible manner.

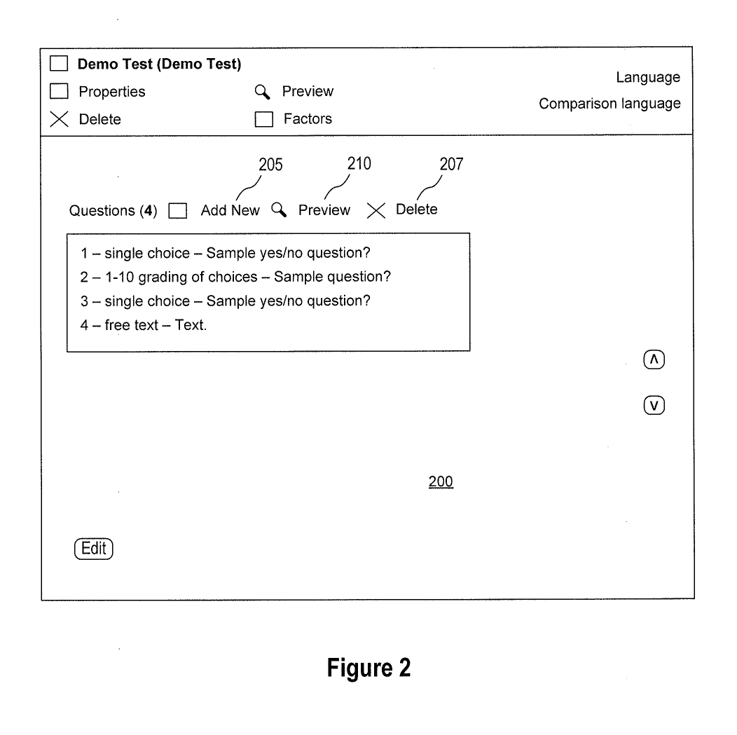

The executable instructions for test generation 122 may accordingly include instructions for receiving input from users and generating custom test, questionnaires, or both. FIG. 2 is a schematic illustration of a user interface for providing information to the computing system 100 for use in generating a test, questionnaire, or both. The user interface 200 may be displayed on a client computing system that may be in communication with the computing system 100 of FIG. 1, or may be displayed on an input/output device 107 of the computing system itself. The user interface may show questions in a test or questionnaire. Four questions are shown in the currently-viewed test in FIG. 2. Each question may have a question type, such as but not limited to, a single choice question, a multiple-choice question, a graded question, or free text. Any number of question types may be used. The question types may specify how responses are displayed to a test taker—e.g. two possible answers and corresponding selectors for single choice questions, multiple possible answers and corresponding selectors for multiple choice questions, 1-10 or other grades for graded choices, or an open text box for a free text question. The question to be displayed to the test taker may also be shown in the user interface 200. To add questions to a test, a user may select ‘add new’ 205, such as by touching the screen or clicking with a mouse. Questions may be deleted by highlighting the question and selecting ‘delete’ 207. An entire test may be previewed by selecting ‘preview’ 210.

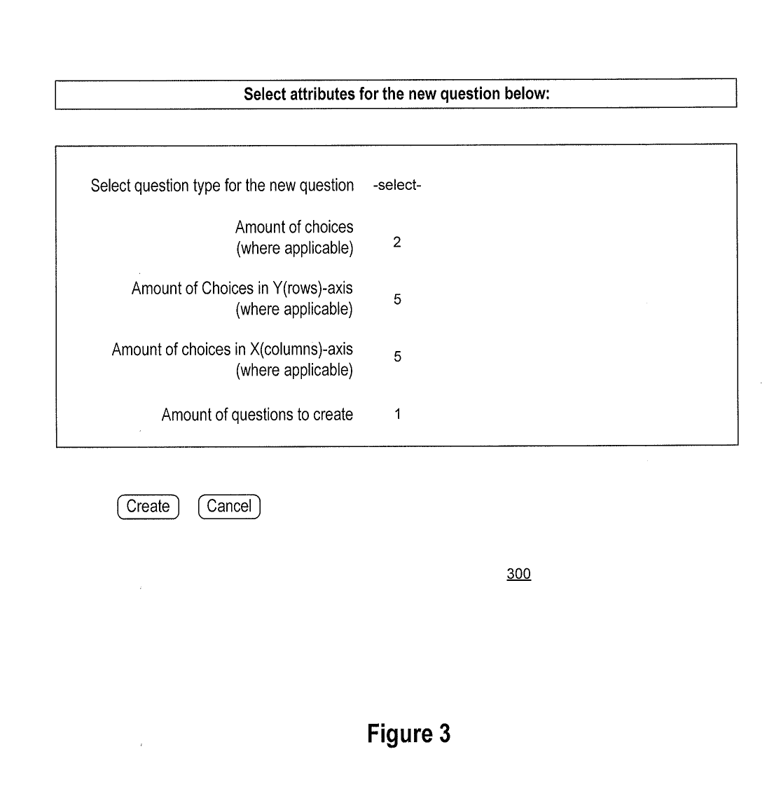

FIG. 3 is a schematic illustration of a user interface for adding questions to a test or questionnaire in accordance with an embodiment of the present invention. Responsive to selecting ‘add new’ 205 in the interface 200 of FIG. 2, the interface 300 of FIG. 3 may be displayed. A user may select from, for example, a drop-down menu a question type for a new question to be added. A number of choices may also be selected from, for example, a drop-down menu, as well as the number of choices to be arranged in an x-axis and a y-axis, as shown in FIG. 3. Based on the type of question selected, the executable instructions for test or questionnaire generation 122 of FIG. 1 may format the question and answer choices in a manner appropriate for the type of question—e.g. including an appropriate number of choices, and presenting the appropriate number of answers and type of response mechanism. Response mechanisms may include radio buttons, check boxes or other selectors, or text boxes. After selecting the type of question and response options in the interface 300 of FIG. 3, a user may be prompted to enter text for the question, possible responses, or both.

The executable instructions for test or questionnaire generation 122 of FIG. 1 may include instructions for receiving question types and text from a user of the computing system 100 or client system in communication with the computing system 100. The received question types and text may be stored in the test or questionnaire storage 130. The executable instructions for test or questionnaire generation 122 may include instructions for generating a test or questionnaire having the question types and text input by the user.

The question text and possible responses may be entered in multiple different languages. For example, text for a question #1 may be entered in Spanish, German, and English, although any language and any number of languages may be used. Similarly, answers may be entered in multiple languages. The different language options for each question and answers may also be stored in the test or questionnaire storage 130 of FIG. 1. The executable instructions for language management 126 may include instructions for receiving an indication of a language in which to generate a test or questionnaire, and selecting the appropriate text from the test or questionnaire storage 130 to use in a test or questionnaire.

The executable instructions for test or questionnaire generation 122 may include instructions for sending tests or questionnaires to participants, for example, through email or browser delivery. So, for example, the computing system 100 may receive a request to send a particular test to one or more individuals or entities in a specified language. The instructions for test or questionnaire generation 122 may operate in accordance with the instructions for language management 126 to provide properly formatted code to display the test or questionnaire on a client system with text in the specified language. Responses may then be received by the computing system 100 and stored, for example, as results 138.

Note that the results that are stored may be independent of textual language. For example, the results 138 may include an identification of which option was selected for each of a number of multiple- or single-choice questions or other question types. While free text question responses may be stored as text received in a particular language, the remaining results 138 may be language-independent.

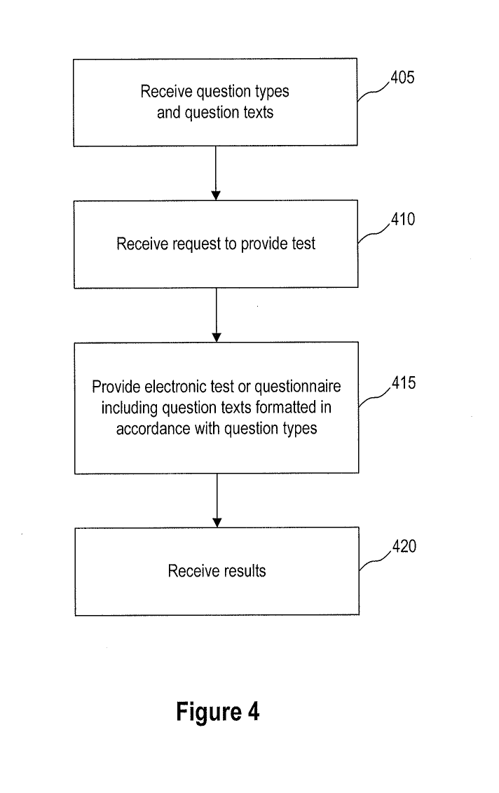

FIG. 4 is a flowchart of a method of generating and providing a text or questionnaire in accordance with embodiments of the present invention. In block 405, question types and question texts, which may include answer texts, may be received. The information may be received, for example by the computing system 100 of FIG. 1. The information may be stored, for examples as tests or questionnaires 130. In block 410, a request may be received to provide a particular test or questionnaire. The request may be received from a client system over a communications interface, or may be received from an input/output device 107 of the computing system 100. The request may specify a particular test or questionnaire, a destination to provide the test or questionnaire, and a language in which to provide the questionnaire. Alternatively, the computing system 100 may have stored an association between a particular destination, individual, or entity and a language. So for example, all requests for tests or questionnaires to be provided to a particular country, company, or domain, may be formatted using an associated language (e.g. all tests sent to a German company may be formatted in German). The request may include a delivery format, e.g. e-mail, browser delivery, text message.

In block 415, the test or questionnaire may be provided including the question texts formatted in accordance with the question types received in block 405. The appropriate language for the texts may have been selected in accordance with the request of block 410. The executable instructions for test or questionnaire generation 122 and language management 126 may include instructions for providing the test or questionnaire in block 415. A recipient may then complete the test or questionnaire by responding to the various questions, and results may be received in block 420. As mentioned above, the computing system 100 of FIG. 1 may receive the results and may store them as results 138. The results 138 may include which option was selected for each of the questions in the test. The results 138 may accordingly be independent of language. Results may be later displayed, emailed or otherwise communicated to particular individuals, or analyzed for other types of data display, some of which will be described further below.

Systems and methods for report generation will now also be described that may be used independently of or in combination with the test or questionnaire generation and providing systems and methods described above. Reports may be defined in a flexible manner, such as by use of XML documents. Report definitions 134 are shown in other memory 112 of FIG. 1, for example. Report definitions 134 may include XML documents that specify options for text to include in a report. For example, reports may include particular content if the results 138 of a test or questionnaire indicate that a respondent falls in a particular category. So, for example, a report definition may specify text for inclusion if the results 138 meet certain criteria. For tests that are scored, a report definition may specify particular text for inclusion if the results 138 indicate a score at or above (or at or below) a threshold value.

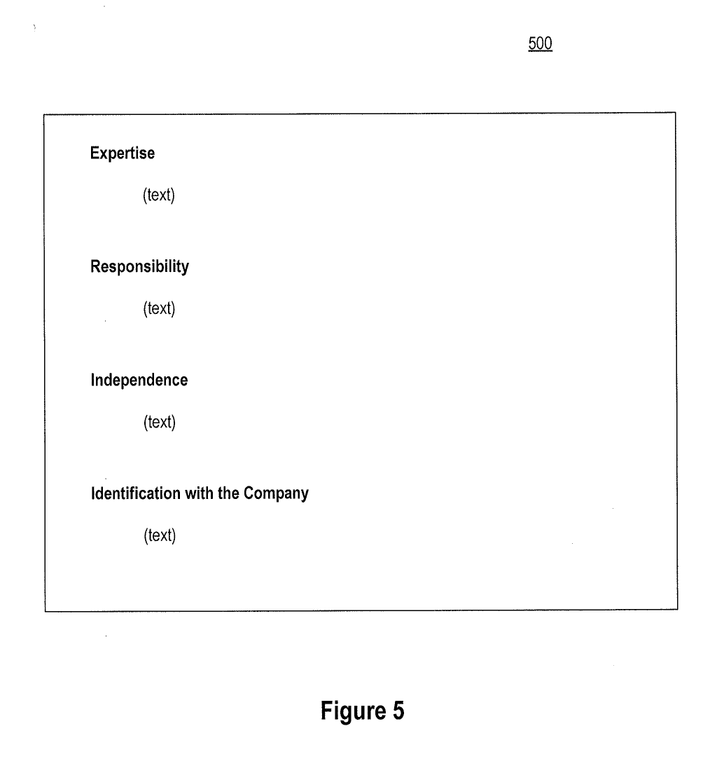

FIG. 5 is a schematic illustration of a report displayed in accordance with an embodiment of the present invention. The report 500 is responsive to a test or questionnaire that evaluated four aspects of a respondent. Generally, any number of aspects may be used in other embodiments. The report 500 includes headers identifying each of these aspects—‘Expertise’, ‘Responsibility’, ‘Independence’, and ‘Identification with the Company.’ Each header may have text included under the header, where the particular text included in the completed report is selected based on a respondent's scores. The report definitions 134 of FIG. 1 may accordingly specify, for a particular test or questionnaire, rules regarding which responses result in which text displayed with each header. In this manner, a respondent (or other individual) may learn something about the respondent based on their test or questionnaire responses. The executable instructions for report generation 120 of FIG. 1 may include instructions for reading the report definitions 134, accessing the results 138, and generating the completed report 500 of FIG. 5.

Because report definitions 134 may be provided in a flexible manner, such as XML documents, language flexibility may also be provided in some examples. That is, the report definitions 134 may not include the actual text themselves for inclusion in the report—either as headers or as text shown in FIG. 5. Instead, the report definitions 134 may include a reference to a particular text ID. For example, an XML report definition 134 may refer to text for inclusion as <text id=“12232”/>. The executable instructions for report generation 120 of FIG. 1 in cooperation with the language management instructions 126 may select text in a particular language corresponding to the text id in the report definition. Accordingly, a report may be requested in a particular language without a need to rewrite report definitions. Instead, text in multiple languages corresponding to the text ID may be stored, and the correct language selected for inclusion in the completed report. In some examples, text in one language may be stored, and translation software may be used to translate the text responsive to a request for a report in another language.

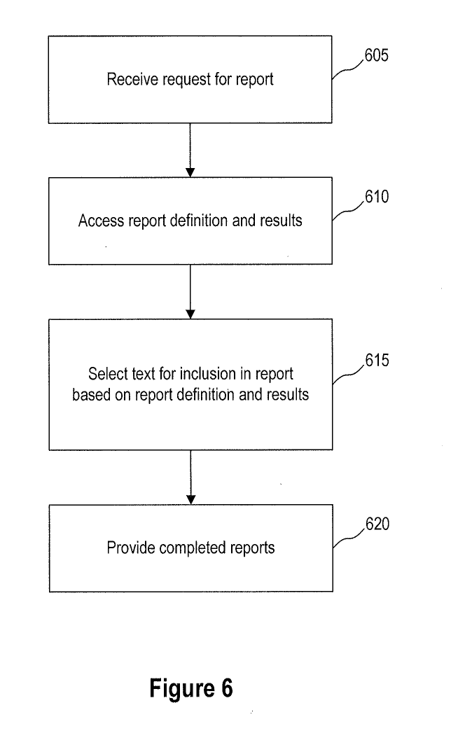

FIG. 6 is a flowchart illustrating a method of providing reports in accordance with an embodiment of the present invention. In block 605, a request for a report may be received. The request may be received, for example by the computing system 100 of FIG. 1. The request may specify a respondent or a group of respondents whose test or questionnaire results are to be used to generate the report. The request may specify a destination for sending the completed report—e.g. email, browser delivery, or other communication. As mentioned above, the request may also specify a language in which to generate the report. The language may be the same as or different than a language in which the original test or questionnaire was administered. That is, a test or questionnaire may be administered to a respondent in one language, and a report may be generated in another language.

In block 610, a report definition and results may be accessed. The report definitions 134 and results 138 of FIG. 1 may be accessed in accordance with the instructions for report generation 120, for example. In block 615, text may be selected for inclusion in a report based on the accessed report definition and results. Referring back to FIG. 1, the instructions for report generation 120 may include instructions for generating a report with the text as specified in the report definitions 134. As mentioned above, the report definitions 134 may include reference to a text ID, and may not include the actual report text themselves. Accordingly, the executable instructions for report generation 120 and language management 126 may include instructions for selecting text corresponding to the text ID in a language specified in the request. In some examples, the language may not explicitly be specified, and a language may be selected based on other factors—e.g. the location or identity of a person to whom the report will be sent.

In block 620, a completed report may be provided. The completed report may be stored in memory 112 of FIG. 1 as reports 136. The completed report may be displayed on an input/output device 107 of FIG. 1. The completed report may be communicated to another system over a communications interface 109 of FIG. 1. In some examples, the completed report may be provided as a .pdf file and may be emailed, delivered to a browser, sent or notified via text message, or the like.

Accordingly, as has been described above, reports may be generated using text selected based on responses to tests or questionnaires. The reports may be generated in a specified language, which may be a different language than that in which the test or questionnaires were originally administered.

Embodiments of the present invention may further include profile analysis for evaluating individuals or groups against predetermined profile criteria. Particular profiles may be stored, e.g. profiles 132 of FIG. 1. The profiles may specify a particular score or range of scores for different aspects of a respondent that fit a profile. For example, a test may evaluate several aspects of a respondent—e.g. analytical ability, personality, and responsibility. Profiles 132 may include one group of values for these aspects representative of one category, e.g. ‘engineer’, and another group of values for these aspects representative of another category, e.g. ‘salesman’. Accordingly, a user may specify values for a profile of a desirable engineer, and different values for a profile of a desirable salesman.

Results may then be compared to these profiles, and a profile coefficient may be calculated for each scored test relative to the profile. This may be accomplished through any of a variety of mathematical mechanisms. In some examples, the profile coefficient will range within a fixed range, e.g. −100 to 100 in some examples, 0 to 100 in other examples, −10 to 10 in other examples, 0 to 10 in other examples. The profile coefficient may be calculated in any of a variety of ways. In one example, a test score for each aspect is compared with the profile. A ‘neutral match’ may be defined as a match within a particular magnitude of the profile value for that aspect, and may receive a score of ‘1’. A ‘negative match’ may be defined as a value outside of the particular magnitude of the profile value, and may receive a score of ‘−2’. A ‘positive match’ may be defined as a value inside of a smaller magnitude of the profile value that the neutral match, or equal to the profile value. The positive match may receive a score of ‘+2’. The score for all aspects may be summed together to yield a total profile score.

A maximum score may be calculated by multiplying the scores of the aspects having a positive match by 2, and adding the scores of all aspects not having a positive match (without multiplication). The profile coefficient may be calculated by dividing the profile score by the maximum score and multiplying the result by 100. If the result is less than −100 or over +100, it may be defined as −100 or +100 to stay within the range.

By generating a profile coefficient for each returned test, a user may search the test results according to profile coefficient to identify candidates that may best meet the profile criteria.

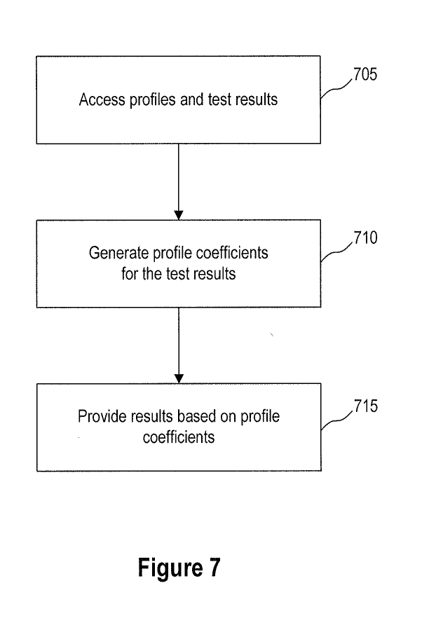

FIG. 7 is a flowchart illustrating a method for providing profile analysis according to an embodiment of the present invention. In block 705, test results and profiles may be accessed. For example, results 138 and profiles 132 may be accessed in accordance with the instructions for profile analysis 124 of FIG. 1. As mentioned above, the profiles 132 may contain specified values for aspects addressed by a test.

In block 710, profile coefficients may be generated for the test results as compared with the profiles. For example, the instructions for profile analysis 124 may include instructions for generating the profile coefficients, example methods for which have been described above. The profile coefficients may be stored, and in some examples may be stored with the results, e.g. results 138 of FIG. 1.

In block 715 results may be provided based on the profile coefficients. For example, the instructions for profile analysis 124 of FIG. 1 may include instructions for responding to a request for results data in accordance with a particular profile. The profile coefficients may be provided, the profile coefficients may be provided along with the results themselves, or in some examples, a certain number of top respondents may be returned corresponding to the highest profile coefficients. So, for example, the instructions for profile analysis 124 of FIG. 1 may include instructions for providing an identity of a top number (e.g. top 1, 2, 3, 4, 5, 6, 7, 8, 9, 10, or more) of respondents based on their profile coefficient against a particular profile. In this manner, a user may ascertain their best candidates for a particular role.

Accordingly, examples of systems and methods for creating, managing, and administering test, questionnaires, or both has been described. Systems and methods described herein may also provide for reporting.

From the foregoing it will be appreciated that, although specific embodiments of the invention have been described herein for purposes of illustration, various modifications may be made without deviating from the spirit and scope of the invention.

What is claimed is:

1. A computing system comprising:
at least one processing unit; and
memory encoded with executable instructions for report generation, wherein the executable instructions for report generation include instructions for, in cooperation with the at least one processing unit, receiving a request for a report, accessing a stored electronic report definition, and accessing stored electronic results, wherein the report definition specifies a text ID for inclusion based on the results, wherein the executable instructions for report generation further include instructions for selecting stored text associated with the text ID in a particular language, and providing a completed report including the text associated with the text ID in the particular language.

2. The computing system of claim 1, wherein the report definition comprises an XML document.

3. The computing system of claim 1, wherein the particular language is included in the request for a report.

4. The computing system of claim 1, wherein the results include responses to a test or questionnaire, and wherein the test or questionnaire was administered in a first language, and wherein the particular language is a second language, different than the first language.

5. The computing system of claim 1, wherein the memory is further encoded with executable instructions for profile analysis comprising instructions for, in cooperation with the at least one processing unit, accessing a stored profile, generating at least one profile coefficient for stored test results based on the test results and the stored profile, and providing the results based on the profile coefficient.

6. The computing system of claim 6, wherein the at least one profile coefficient comprises a numerical value within a predetermined range of values.

7. The computing system of claim 6, wherein the instructions for generating at least one profile coefficient comprise instructions for calculating a total profile score, wherein the total profile score comprises a sum of scores for aspects of the test results having a positive match with the stored profile multiplied by a first value, scores for aspects of the test results having a neutral match with the stored profile multiplied by a second value, and scores for aspects of the test results having a negative match with the stored profile multiplied by a third value.

8. The computing system of claim 7, wherein the instructions for generating at least one profile coefficient comprise instructions for calculating a maximum profile score, wherein the maximum profile score comprises a sum of scores for aspects of the test results having a positive match with the stored profile multiplied by a first value and scores for other aspects of the test results multiplied by a second value.

9. The computing system of claim 8, wherein the instructions for generating at least one profile coefficient comprise instructions for dividing the total profile score by the maximum profile score.

10. The computing system of claim 8, wherein the instructions for providing the results based on the profile coefficient comprises providing identities of respondents associated with a predetermined number of results having a highest profile coefficient.

11. A memory encoded with executable instructions that, if executed, operate to cause a computing system to:
provide a user interface for receipt of predetermined questions types and texts;
receiving selected question types and texts, including versions of the texts in a plurality of languages;
receiving a request to provide a test or questionnaire; and
providing the test or questionnaire formatted in accordance with the question types and texts in a selected language.

12. The computer memory of claim 11, wherein the selected language is provided in the request to provide a test or questionnaire.

13. The computer memory of claim 11, wherein said providing a user interface comprises displaying a menu for entry of the question types and texts.

14. The computer memory of claim 13, wherein said question types are provided in a drop-down menu.

15. The computer memory of claim 13, wherein said instructions further cause the computing system to receive results of the test or questionnaire and store the results in a manner independent of language.

16. The computer memory of claim 15, wherein said instructions further include instructions for causing the computing system to generate a report including the results of the test or questionnaire in a language different than the selected language.

17. A method comprising:
receiving, at a computing system, selected question types from a plurality of predetermined question types;
receiving, at the computing system, question text for each of the selected question types, wherein the question text includes a plurality of versions, each in a respective language;
storing, in an electronic memory of the computing system, a report definition, wherein the report definition specifies report text for inclusion in a report based on results, wherein the report text is identified in the report definition by a text identifier;
storing, in the electronic memory of the computing system, the report text associated with the text identifier in a plurality of versions, each in a respective language;
providing, to a respondent, a test or questionnaire including the
generating, at a computing system, a test or questionnaire including the question text formatted in accordance with the selected question types and in a first selected one of the respective languages;
receiving, at the computing system, results of the test or questionnaire;
generating, at the computing system, a completed report including report text selected based on the results of the test or questionnaire in a second selected one of the respective languages, wherein the second selected one is different than the first selected one.

18. The method of claim 17, the method further comprising:
scoring the results of the test or questionnaire against a stored profile; and
providing the results of the test or questionnaire based on said scoring.

19. The method of claim 17, wherein said report definition comprises an XML file.

20. The method of claim 17, further comprising providing the completed report in an email communication to a recipient.
